(19) United States
(12) Patent Application Publication
(10) Pub. No.: US 2006/0139577 A1
(43) Pub. Date: Jun. 29, 2006

(54) Rear projection display

(75) Inventors: Takashi Ikeda, Osaka (JP); Takashi Miwa, Osaka (JP); Haruhiko Murata, Osaka (JP); Hideyuki Kanayama, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/312,558

(22) Filed: Dec. 21, 2005

(30) Foreign Application Priority Data
Dec. 24, 2004 (JP) 2004-373967

(51) Int. Cl. G03B 21/22

(52) U.S. Cl. 353/74

(57) ABSTRACT

A rear projection display, not requiring a dichroic prism, and capable of rendering a generation system of each image light in color independent of the other generation systems so as to optimally construct and improve easiness of assembly of, and so on, each generation system, is provided. Each unit for projecting image-light is formed of an LED array, a rod integrator, a liquid crystal display panel, and a projection lens. A projection optical axis of the projection lens of each unit for projecting image-light is parallel each other. A unit for projecting image light in red is provided with an LED array for emitting light of a wavelength band in red, a unit for projecting image light in green is provided with an LED array for emitting light of a wavelength band in green, and a unit for projecting image light in blue is provided with an LED array for emitting light of a wavelength band in blue. Each image light in color obtained as a result of passing through the liquid crystal display panel is projected by the projection lens, and displayed on a screen. As a result, each image light in color is superposed on the screen, and an image in full color is displayed.

### TECHNICAL FIELD

The present invention relates to a rear projection display.

### BACKGROUND ART

It has been proposed a projection type image display apparatus provided with light sources of three colors for respectively emitting three primary colors, optically modulating by light valves lights of respective colors from the light sources of respective colors, combining by a dichroic prism image lights of respective colors obtained as a result of this optical modulation, and projecting by a projection lens image light in full color obtained as a result of this combination (see Japanese Patent Laying-open No. 2004-220015, referred to as the former invention). In addition, it has been proposed a liquid crystal rear projection television, in which light of respective colors obtained as a result of separating white light from one light source are optically modulated by a liquid crystal display panel, image lights of respective colors obtained as a result of this optical modulation are projected by three projection lenses, and the image lights of respective colors are superposed one another on a screen (see Japanese Patent Laying-open No. H5-333304, referred to as the latter invention).

### DISCLOSURE OF THE INVENTION

However, in an art of the former invention, the image lights of respective colors are combined by the dichroic prism. Thus, there are various drawbacks that light in a certain wavelength band is cut, and because of this cutting, it is not possible to realize high luminance, and so forth. On the other hand, in an art of the latter invention, there is a drawback that it is necessary to make a color separation of the white light from the one light source. In addition, there is another drawback that in this color separation, it is not possible to render equal all the color light's path lengths from the light sources to the liquid crystal display panel. Furthermore, each projection system of the image lights of respective colors does not individually possess a particular light source. Thus, it is not possible for the projection system of the image lights of respective colors to individually exist in such a manner that the projection system of the image lights of respective colors includes the particular light source (that is, not possible to become one assembly). In addition, it is difficult to optimally construct or optimally control the light sources in each projection system of the image lights of respective colors.

In view of the above circumstances, it is an object of the present invention to provide a rear projection display, not requiring a dichroic prism and capable of rendering the generation system of each image light in color independent of the other generation systems so as to optimally construct, improve easiness of assembly of, and so on, each projection optical system.

In order to solve the above problem, a rear projection display of the present invention comprises a plurality of optical systems for projecting image light in color, each of the plurality of optical systems for projecting image light in color formed of a light source for emitting light in color, a light valve for generating image light in color by transmitting or reflecting the light in color from the light source, and a projection portion for projecting the image light in color obtained as a result of passing through the light valve, in which each of the image light in color from each of the optical systems for projecting image light in color is superposed one another on a rear side of a screen, and as a result, an image in full color is displayed.

In the above configuration, it is possible to be liberated from disadvantages and various constraints of a case of using the dichroic prism. In addition, it is possible for the plurality of optical systems for projecting image light in color to individually exist in such a manner that each of the plurality of optical systems for projecting image light in color includes the light source. Thus, it becomes easy to bring into a unit. For example, the light valve and the light source are rendered a unit, or the projection portion, the light valve, and the light source are rendered a unit. This increases easiness of assembly or accuracy of assembly. Furthermore, it becomes possible to individually construct or control the light sources depending on each optical system for projecting image light in color so that the rear projection display can optimally perform.

In a rear projection display of the above configuration, each of the optical systems for projecting image light in color is preferably provided with an optical integrator for guiding to the light valve the light in color from the light source so as to render uniform intensity of the light in color within a surface of the light valve.

Furthermore, in these rear projection displays, each of the optical systems for projecting image light in color is preferably provided with a polarization conversion system for supplying to the light valve light in color of which polarization direction is directed to a common direction.

In addition, in these rear projection displays, it is preferable that projection optical axes of the projection portions in the plurality of optical systems for projecting image light in color are parallel each other, and the light valve or a component including the light valve in all or at least one optical system for projecting image light in color is shifted relative to the projection optical axes of the projection portions. In addition, in such the configuration, all or at least one optical system for projecting image light in color is preferably provided with an optical-axis shift mechanism for shifting the light valves or the components including the light valves within a surface, of the optical integrator and perpendicular to the projection optical axis. Or, all or at least one optical system for projecting image light in color is preferably provided with an optical-axis shift mechanism for shifting the projection portion of the optical system for projecting image light in color within a surface perpendicular to the projection optical axis.

Furthermore, in these rear projection displays, an optical system for projecting image light in color provided with a light source of which light amount is smaller than those of the light sources of the other optical systems for projecting image light in color is preferably provided with a light valve larger in size than the other light valves.

In addition, these rear projection displays may comprise, as the plurality of optical systems for projecting image light in color, an optical system for projecting image light in red for projecting image light in red, an optical system for projecting image light in green for projecting image light in green, and an optical system for projecting image light in blue for projecting image light in blue. In such the configuration, the plurality of optical systems for projecting image light in color are arranged in such a manner that lines connecting centers of the optical axes of the optical systems for projecting image light in color are in a triangular shape.

Furthermore, these rear projection displays may comprise, as the plurality of optical systems for projecting image light in color, an optical system for projecting image light in red for projecting image light in red, an optical system for projecting image light in green for projecting image light in green, an optical system for projecting image light in blue for projecting image light in blue, and an optical system for projecting image light in another color for projecting image light in another color having a central wavelength different from those of the above colors. In such the configuration, the plurality of optical systems for projecting image light in color may be arranged in two rows and two lines so that lines connecting centers of the optical axes of the optical systems for projecting image light in color are in a square shape.

In addition to the above-described triangular or square shape, the plurality of optical systems for projecting image light in color may be arranged abreast so that the projection optical axes of the optical systems for projecting image light in color exist within the same plane.

In addition, in these rear projection displays, the light source may be formed of one or a plurality of solid light-emitting elements.

Furthermore, these rear projection displays may comprise a transmission-type liquid crystal display panel without a micro lens array as the light valve.

In addition, in these rear projection displays, curved-surfaced mirrors may be arranged on respective projection sides of the image light in color of the plurality of optical systems for projecting image light in color.

Furthermore, in these rear projection displays, the light sources of the plurality of optical systems for projecting image light in color may be arranged on the same plane, and the light sources may be cooled by a common cooling device. In such the configuration, the cooling device may be a liquid-cooling device.

In addition, in these rear projection displays, it may be possible that dust is removed from air taken-in so as to generate cleansed air, and the cleansed air is blown so as to cool the light valves of the plurality of optical systems for projecting image light in color.

According to the present invention, it is possible to be liberated from disadvantages and various constraints of a case of using the dichroic prism. In addition, it is possible for the plurality of optical systems for projecting image light in color to individually exist in such a manner that each of the plurality of optical systems for projecting image light in color includes the light source. Thus, it becomes easy to bring into a unit. This increases easiness of assembly or accuracy of assembly. Furthermore, it becomes possible to individually construct or control the light sources depending on each optical system for projecting image light in color so that the rear projection display can optimally perform.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a side view showing internal structure (optical system) of a rear projection display of an embodiment of the present invention;

FIG. 2 is a descriptive diagram showing internal structure of an image-light generation optical unit provided in the rear projection display of FIG. 1;

FIGS. 3A, 3B are descriptive diagrams showing arrangement examples of (three) projection lenses;

FIGS. 4A, 4B are descriptive diagrams showing arrangement examples of (four) projection lenses;

FIG. 5 is a descriptive diagram of an LED array provided with a polarization conversion system;

FIG. 6 is a descriptive diagram showing a configuration example of a unit for projecting image-light in a case of using a reflective type liquid crystal display panel; and

FIG. 7 is a side view showing internal structure (optical system) of a rear projection display of another embodiment of the present invention.

### DESCRIPTION OF THE PREFERRED EMBODIMENT

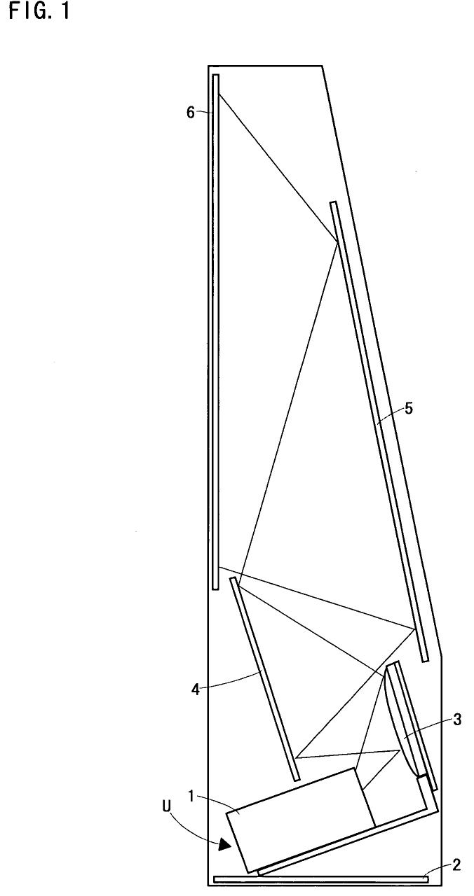

Hereinafter, a rear projection display of an embodiment of the present invention will be described based on FIG. 1 to 7.

FIG. 1 is a side view showing internal structure (optical system) of the rear projection display of this embodiment. At a lower structural portion of a chassis 2 of the rear projection display, a position adjustment mechanism (not shown) is provided, and on this position adjustment mechanism, an image-light generation optical unit U is mounted. The image-light generation optical unit U is formed of an optical system for generating image light 1 and three aspheric mirrors 3. Image lights of respective colors emitted from the optical system for generating image light 1 are reflected by each of the aspheric mirrors 3. Furthermore, at a position where the image lights of respective colors reflected by the aspheric mirrors 3 are received, a reflecting mirror 4 is placed. The reflecting mirror 4 is attached to the chassis 2 by an adjustment screw (not shown) so that an angle of the reflecting mirror 4 is freely adjustable. The image light reflected by the reflecting mirror 4 is guided to a rear-surface mirror 5. As a result of the image light being reflected by this rear-surface mirror 5, the image light reaches a rear side of a screen 6, and projected on the screen 6. Consequently, a user observes an image projected on the screen 6.

Needless to say, as the configuration in which the image light is guided to the screen, such a reflective optical system is not the only system for guiding the image light to the screen. For example, it may be possible to adopt a configuration in which a plane-surface mirror is arranged instead of the aspheric mirror 3. Or, as shown in FIG. 7, it may be possible that the image is directly projected from the image-light generation optical unit U to the rear-surface mirror 5, and the image light is reflected by the rear-surface mirror 5 and guided to the screen 6. Furthermore, in another configuration, different types of optical path systems (for example, an optical-path system in which a long optical-path length is secured by utilizing a polarization, an optical-path system in which the image light is guided to the reflective optical system from an upper side of the screen 6, and the image light is guided to the screen by this reflective optical system, etc.) can be used.

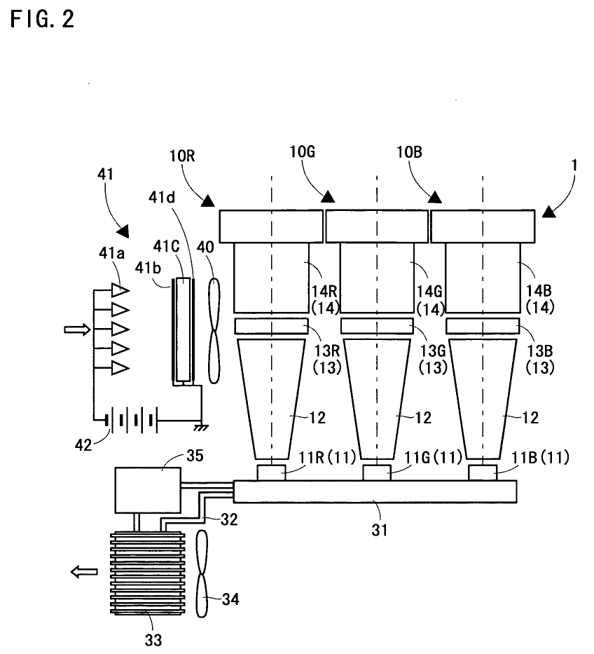

FIG. 2 is a descriptive diagram showing the optical system for generating image light 1. This optical system for generating image light 1 is provided with a unit for projecting image light in red 10R, a unit for projecting image light in green 10G, and a unit for projecting image light in blue 10B (hereinafter, a numeral “10” is used for generally referring to each unit for projecting image light). These units for projecting image light 10R, 10G, and 10B are arranged abreast such that projection optical axes thereof exist in the same plane. In this embodiment, a direction in which the units for projecting image light 10R, 10G and 10B are aligned corresponds to a width direction of the rear projection display (in a vertical direction toward a paper face in FIG. 1). However, this is not always the case, and the units for projecting image light 10R, 10G, and 10B are arranged in a height direction of the rear projection display, and in other directions.

Each unit for projecting image light 10 is formed of an LED array 11, a rod integrator 12, a liquid crystal display panel 13 (13R, 13G, 13B), and a projection lens 14 (14R, 14G, 14B). The unit for projecting image light in red 10R is provided with an LED array 11R for emitting light in a wavelength band in red, the unit for projecting image light in green 10G is provided with an LED array 11G for emitting light in a wavelength band in green, and the unit for projecting image light in blue 10B is provided with an LED array 11B for emitting light in a wavelength band in blue. Each LED array 11 has a plurality of LEDs (light-emitting diodes) arranged in the same plane, and is in a plane shape. An emission optical-axis of each LED (primary light beam) is set to be perpendicular to the plane surface (plane surface where the LEDs are arranged). Each light in color emitted from each LED array 11 is incident upon the rod integrator 12. Optical intensity of each light in color is rendered uniform by this rod integrator 12. Thereafter, each light in color of which optical intensity is rendered uniform is exited from the light-emission surface of the rod integrator 12.

The rod integrator 12 has squared-tube structure of which inner surface is a mirror surface (hollow structure), or squared-pole structure (glass rod). The rod integrator 12 is in a sectional squared shape of which light exit (light-exit surface) is larger than a light entry (light-incidence surface). A shape and a size of the light exit are equal to or approximately equal to those of the liquid crystal display panel 13. Needless to say, the sizes of the light entry and the light exit of the rod integrator 12 may be the same, or the size of the light entry may be larger than that of the light exit. The liquid crystal display panel 13 provided on the light-exit side of the rod integrator 12 modulates the incident light based on an image signal, and as a result of this optical modulation, the image lights of respective colors are generated. The liquid crystal display panel 13 is transmissive-type, and is without a color filter (color films formed to be corresponded to each dot). As the liquid crystal display panel 13, a liquid crystal display panel without a micro lens array (micro convex lens formed to be corresponded to each dot) may be used. In addition, the liquid crystal display panel 13 is arranged close to a lens on a light-incidence side of the projection lens 14 (that is, a back-focus of the projection lens 14 is short). Each image light of respective colors obtained as a result of passing through the liquid crystal display panel 13 is projected by the projection lens 14, and projected on the screen 6 via the mirrors 3, 4, and 5. Each image light of respective colors is superposed one another on the screen 6, and thus, an image in full color is displayed.

The projection optical axes of the projection lens 14 in each unit for projecting image light 10 are parallel each other. It is noted that herein, in a certain construction (certain screen size, etc.), in a case of constructing such that the projection optical axes of the three projection lenses 14 are intersected on the screen 6, the unit U cannot be used as it is in another construction. On the other hand, if the projection optical axes of the three projection lenses 14 are parallel each other, it becomes possible to commonly use this unit U in a plurality of constructions.

Of the liquid crystal display panels 13, the liquid crystal display panel for light in green 13G is fixedly provided, and the liquid crystal display panel for light in red 13R and the liquid crystal display panel for light in blue 13B are supported by a position adjustment mechanism (shift mechanism) so that these panels are capable of rotating and making a parallel movement in a plane surface vertical toward the optical axes. For example, this position adjustment mechanism is formed of a base having an aperture as approximately large as that of the liquid crystal display panel, a supporting plate supported by this base and supporting the liquid crystal display panel, a guide mechanism guiding this supporting plate, an adjustment screw for providing the supporting plate with a moving force, etc. There is no one specific configuration in which the position adjustment mechanism is constructed, and an existing mechanism (for example, see Japanese Patent Laying-open No. H8-122599) may be used. Even if the projection optical axes of the three projection lenses 14 are parallel each other, the position adjustment mechanism allows the optical axes of the liquid crystal display panel 13R and the liquid crystal display panel 13B to be shifted, so that it becomes possible to exactly superpose a projection image light in red and a projection image light in blue on a projection image light in green on the screen 6.

Incidentally, in each unit for projecting image light 10, in a case that all centers of the projection lens 14, the liquid crystal display panel 13, the rod integrator 12, the light source 11 are set straight, and only the liquid crystal display panel 13 is shifted, it is needed that an area of the light exit of the rod integrator 12 is rendered large enough to cover a shift range in which the liquid crystal display panel 13 is shifted. Instead of shifting only the liquid crystal display panel 13, it may be configured such that the liquid crystal display panel 13, the rod integrator 12, and the light source 11 are rendered one unit, and the optical axis is shifted by this unit. It may also be configured such that the optical axis of the liquid crystal display panel 13 is shifted in advance at a constructing stage to a certain position relative to the projection optical axis of the projection lens 14 (for example, a position corresponding to a middle point of a certain screen size and another certain screen size), and this position is used as an initial position. Then, a shift amount of the liquid crystal display panel 13 may be adjusted based on this position. Or, a lens shift mechanism may be provided so that the projection lens 14 is moved within a surface vertical to the projection optical axis thereof. It is noted that although in the above description, the liquid crystal display panel for light in green 13G is fixedly provided, the position adjustment mechanism (shift mechanism) may also be provided in the liquid crystal display panel for light in green 13G or a component including the liquid crystal display panel for light in green 13G.

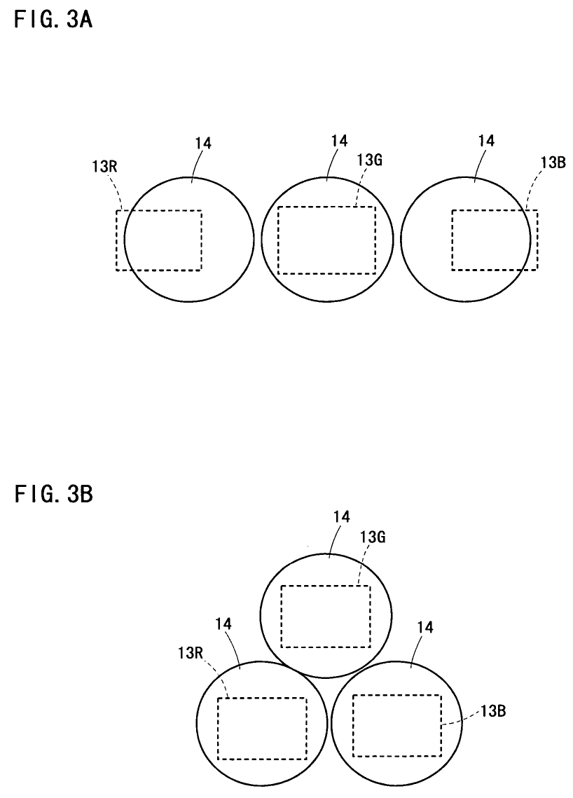

FIG. 3A shows a positional relationship (optical axis shift) between the projection lenses 14R, 14G and 14B, and the liquid crystal display panels 13R, 13G and 13B. It is noted that in a configuration example shown in FIG. 3A, a panel size of the liquid crystal display panel for light in green 13G is larger than those of the liquid crystal display panel for light in red 13R and the liquid crystal display panel for light in blue 13B (resolution of each display panel is the same). Generally, in many cases, a light amount of the LED array 11G for emitting the light in green is smaller than those of the other LED arrays 11R, 11B. Therefore, in this case, the panel size of the liquid crystal display panel for light in green 13G is rendered larger than those of 1E the other display panels so as to increase brightness of the projection image light in green on the screen 6. It is noted that the area of the light exit of the rod integrator 12 of the unit for projecting light in green 10G and a projection magnification of the projection lens 14G are changed corresponding the liquid crystal display panel 13G being rendered large.

As shown in FIG. 3B, three pieces of the units for projecting image light 10 may be arranged so that lines connecting the optical axes of the projection lenses 14 form a triangle. In this case, too, the projection optical axes of the three projection lenses 14 are preferably rendered parallel each other. In addition, the position adjustment mechanism is provided for the optical axis shift, and so on. In the position adjustment mechanism used in this case, there is an advantage that the shift amount of the liquid crystal display panel 13, etc., is rendered small. In these configurations, the position adjustment mechanism is provided in all, or at least one unit.

As shown in FIG. 2, the LED arrays 11R, 11G and 11B are positioned on the same plane. In addition, these LED arrays 11R, 11G, and 11B are provided in such a manner as to be in contact with a heat conductive portion 31 for conducting heat generated by the LED arrays to cooling liquid. The heat conductive portion 31 is joined to a radiator (heat exchanger) 33 by a pipe 32. In the vicinity of the radiator 33, a fan (axial flow fan, etc., for example) 34 is provided. Air blown by the fan 34 draws heat from the radiator 33, and air of which temperature has risen is discharged outside of the unit U. In addition, the cooling liquid cooled by passing through the radiator 33 is once again circulated to the heat conductive portion 31 by a pump 35. It is noted that in addition to such the liquid-cooling system, it may be possible to adopt a configuration in which the LED arrays 11R, 11G, and 11B are arranged on a surface (plane surface) of a metal plate on which fins are formed at a reverse, and cooling air is blown to the fins by the fan, for example, and other configurations. In a case of a configuration in which an optical system portion of the unit U is contained in a case, the radiator 33 is preferably provided outside of the case, and the fan 34 may be provided inside of the case. In this case, the fan 34 takes in the air inside of the case so as to exhaust the air to outside of the case. For this exhaust, an exhaust duct leading outside of a main body of the rear projection display (outside of the apparatus) may be provided.

Between each liquid crystal display panel 13 and the light-exit surface of the rod integrator 12, and between each liquid crystal display panel 13 and the projection lens 14, a gap for cooling is formed. An air-supply fan (axial flow fan, sirocco fan, etc., for example) 40 is provided so that the cooling air is blown to this gap. It may be possible that a duct is provided at an air-supply port of the air-supply fan 40, and the cooling air is supplied to each liquid crystal display panel 13 . . . through this duct. On an air-taking-in side of the air-supply fan 40, a dust eliminator 41 is provided. In a cubed tube body (not shown) of this dust eliminator 41, needle electrodes 41a. . . , a conductible first mesh filter 41b, a honeycomb-shaped filter 41c, and a conductible second mesh filter 41d are arranged in this order along an airflow direction. The first mesh filter 41b and the second mesh filter 41d are arranged in such a manner as to sandwich the honeycomb-shaped filter 41c. In the honeycomb-shaped filter 41c, a multiplicity of honeycomb tube portions are arranged within a plane, and these portions are set to several centimeters in thick, for example. In addition, in this embodiment, a base material of the honeycomb-shaped filter 41c is paper, and the honeycomb-shaped filter 41c has a function as an ozone decomposition catalyst filter. More specifically, in the honeycomb-shaped filter 41c, catalysts such as manganese dioxide, nickel oxide, activated charcoal, etc., are impregnated to an inner wall of the honeycomb-shaped tube portion. Needless to say, the honeycomb-shaped filter 41c may be formed not only of paper, but also of a conductible material, a resin material, a ceramic material, etc.

In the above dust eliminator 41, air, dust, etc., are negatively ionized by a corona discharge by a multiplicity of negative-side needle electrodes 41a, this negatively ionized air, dust, etc., are drawn by the first and second mesh filters 41b, 41d, which are grounding wire-side electrodes, so as to cause airflow, and in addition, the dust is adsorbed by the honeycomb-shaped filter 41c, and the first and second mesh filters 41b, 41d. In this embodiment, the above honeycomb-shaped filter 41c is connected to a grounding wire. A high-voltage generation circuit 42 receives voltage supply from a power supply not shown, causes high voltage ranging from a few negative kilovolts to ten and several negative kilovolts, and applies this high voltage to the needle electrodes 41a.

Lengths of diameters (in a case of a circular shape) or one edge (in a case of a square shape) of mesh apertures of the first and second mesh filters 41b, 41d, are set to approximately ten times a size (10 μm (micrometers)-20 μm) of dots of the liquid crystal display panel 13, for example. In addition, a size of an aperture of the honeycomb-shaped filter 41c is set to several mm (millimeters), for example. These honeycomb-shaped filters 41c, and the first and second mesh filters 41b, 41d, may be detachably provided. It is noted that in addition to the dust eliminator using such the ionized wind, a dust eliminator of another mechanism may be used.

In the above example, the optical system for generating image light 1 is provided with the three pieces of the units for projecting image light 10 (3-system independent projection system), that is, the unit for projecting image light in red 10R, the unit for projecting image light in green 10G and the unit for projecting image light in blue 10B. However, this is not always the case. The optical system for generating image light 1 may be provided with four pieces of the units for projecting image light 10 (4-system independent projection system) that is, the unit for projecting image light in red 10R, a first unit for projecting image light in green 10G1, a second unit for projecting image light in green 10G2, and the unit for projecting image light in blue 10B, for example. The first unit for projecting image light in green 10G1 and the second unit for projecting image light in green 10G2 are projection units in which center wavelengths of the light in green are rendered somewhat different (the light may be somewhat yellow), and an LED emitting light of such the wavelength is used. Furthermore, the four pieces of the units for projecting image light 10 may be configured such that the image light in red, the image light in green, the image light in blue, and the image light in orange are generated. To the liquid crystal display panel 13 of each unit for projecting image light 10, image signals of the colors of each unit are supplied. The four image signals can be generated by using a luminance signal and a color-difference signal (R-Y, B-Y), that is, an original signal (see Japanese Patent Laying-open No. H10-148885, for example).

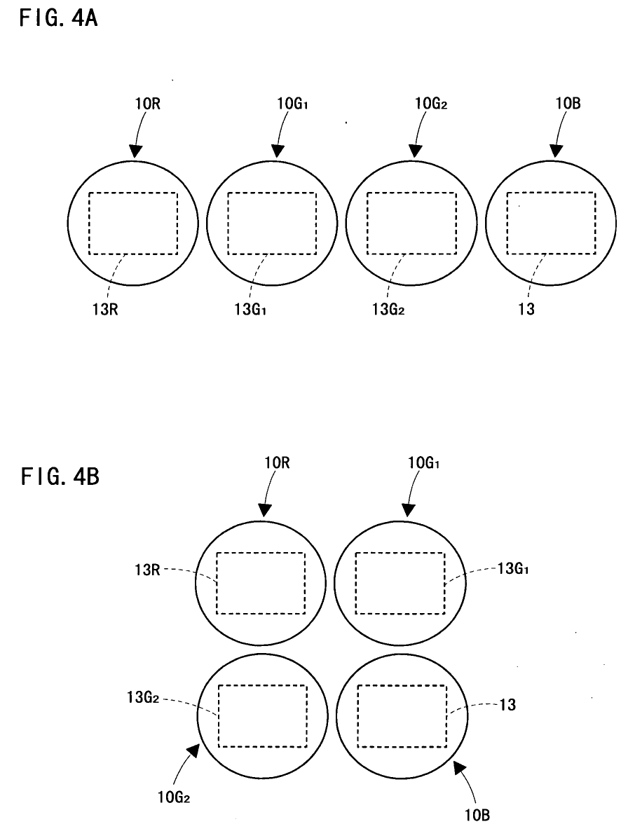

FIGS. 4A, 4B show arrangement examples of the four pieces of the units for projecting image light 10 . . . . In FIG. 4A, the four pieces of the units for projecting image light 10 . . . are arranged abreast so that optical axes thereof are placed within the same plane. In addition, in FIG. 4B, the four pieces of the units for projecting image light 10 . . . are arranged in 2×2 (two by two) so that lines connecting the optical axes thereof form a square. In these configurations, too, the position adjustment mechanism is provided for the optical axis shift, etc., in all, or at least one of the four pieces of the units for projecting image light 10.

In either configuration of the 3-system independent projection system or the 4-system independent projection system described above, too, a dichroic prism for mixing the image light is rendered unnecessary. Therefore, as described below, it is possible to solve a drawback of a case that the dichroic prism is used. For example, it is possible to solve a drawback of a loss of a light amount caused by a cutting-off characteristic of the dichroic prism.

In addition, in the configuration of using the dichroic prism, in view of the characteristic of the prism, the light in green is S-polarized light, and the light in other colors are P-polarized light, and a narrow-band retardation plate (for converting the S-polarized light into the P-polarized light regarding only a band of the light in green) is provided on a light-exit side of the dichroic prism. However, now that the optical system for generating image light 1 is rendered an independent projection system, it becomes possible to convert the image light in green, too, into P-polarized image light.

In addition, in the case of using the dichroic prism, each liquid crystal display panel recedes from the projection lenses by a size of the dichroic prism. In contrary thereto, if the independent projection system is used, it is possible to arrange the liquid crystal display panel 13 close to the lens on a light-incidence side of the projection lens 14. That is, it is possible to use a projection lens 14 having a short back-focus and of which F number is small. Even if a divergence angle of the image light obtained as a result of passing through the liquid crystal display panel 13 is somewhat large, it becomes possible to use the projection lens 14 of which F number is small, so that bright image light can be projected by enhancing usage efficiency of the light. Herein, parallelism of the light that the LED array or the LED emits is low, so that it is preferable to use a liquid crystal display panel 13 without the micro lens array. In addition, in a case that the liquid crystal display panel 13 without the micro lens array is thus used, the usage efficiency of light is further improved if the projection lens 14 of which F number is small is used. Needless to say, the use of the liquid crystal display panel provided with the micro lens array is not to be excluded.

In addition, in the case of using the dichroic prism, all image light in color are projected by one projection lens, and in this case, the projection lens requires an achromatic lens. In contrary thereto, if the independent projection system is used, each image light in color is projected by each projection lens, so that no achromatic lens is required for the projection lens 14. The achromatic lens is formed of a combination of glass lenses of which dispersion differs, and if this achromatic lens is not required, it becomes possible for the projection lens 14 to be formed of a lens made of plastic (resin), so that it becomes possible to obtain an advantage in which it is possible to construct the lens of which lens surface is an aspheric surface, which is not easy if the lens is made of a glass material. In addition, the number of lenses is reduced, and thus, possible to reduce a cost of constructing the projection lens 14.

Furthermore, the plurality of units for projecting image light 10 . . . can individually exist in such a manner that each of the plurality of units for projecting image light 10 . . . possesses the LED array 11. Thus, this makes it easy to bring into a unit. Such the unit may include a unit of the liquid crystal display panel 13 and the LED array 11, or a unit of the liquid crystal display panel 13, the rod integrator 12, and the LED array 11, or a unit of the liquid crystal display panel 13, the rod integrator 12, a polarization conversion system described later, and the LED array 11, or a unit of the projection lens 14, the liquid crystal display panel 13, the rod integrator 12, the polarization conversion system described later, and the LED array 11. This increases easiness of assembly or accuracy of assembly. Furthermore, it also becomes possible to independently construct or control the LED array 11 (the number of LEDs in each LED array, an array size, a control of supplied voltage to the LED, a driving control of a pulse light emission of the LED, presence or absence of an optical system for combining the LED emission light, etc.) by each unit for projecting image light 10. In addition, in a case of the independent projection system not using the dichroic prism, as shown in FIG. 3A, it becomes easy to use the liquid crystal display panels 13 of which sizes differ depending on each projection system, and thus possible to easily render larger a panel size of only the liquid crystal display panel 13 for image light in color of which light amount is not sufficient, and so forth.

In addition, if the independent projection system is used, a degree of freedom of where each projection system is arranged is high, and in addition, it becomes possible to realize the short back-focus described above. From this point, a degree of freedom of where components of the image light generation system 1 are arranged is increased, and thus, it also becomes easy to reduce the rear projection display in size.

Although in the examples described above, each projection system is provided with the rod integrator 12, an optical integrator formed of one pair of fly's eye lenses may be used instead of this rod integrator 12. In addition, in a case of using the optical integrator formed of this pair of fly's eye lenses, it is preferable that a polarization conversion system formed of a polarizing beam splitter array is provided, and light guided to the liquid crystal display panel 13 is redirected to the S-polarized light or to the P-polarized light. Furthermore, in a case of adopting the rod integrator 12, too, the polarization conversion system may be provided on a light-exit side of this rod integrator 12. In this case, a size of a light-exit portion of the polarization conversion system is twice that of the light-exit portion of the rod integrator 12. Therefore, it is preferable that an aspect ratio of a whole shape of the light-exit portion of the polarization conversion system is approximately equal to that of the liquid crystal display panel 13. In this case, if an aspect ratio of the liquid crystal display panel is A:B, an aspect ratio of the light-exit portion of the rod integrator 12 is A:B/2, for example.

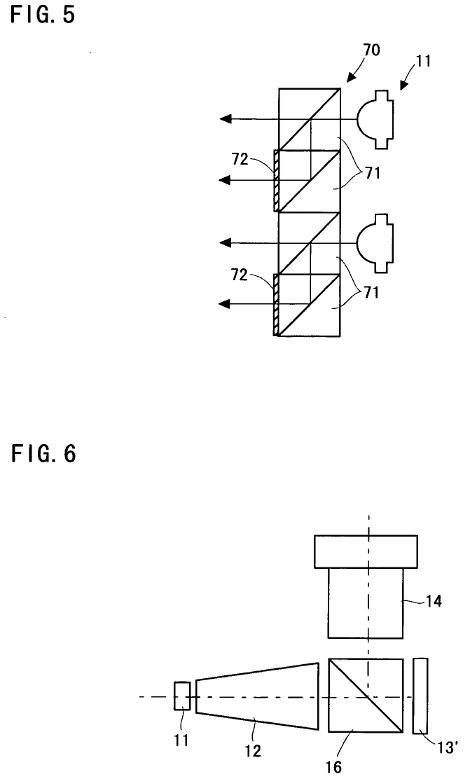

In addition, as shown in FIG. 5, a polarization conversion system 70 may be provided on the light-exit side of the LED array 11. A basic unit (corresponds to a size of the light-exit portion of each LED) of the polarization conversion system 70 is formed of two polarizing beam splitters (PBSs) 71, and a retardation plate (½ λ plate) 72 arranged on a light-exit side of one of the two polarization beam splitters 71. A polarized light separating surface of each polarization beam splitter 71 transmits the P-polarized light, and changes an optical path of the S-polarized light by 90 degrees. The S-polarized light having the optical path changed is reflected by an adjacent polarized light separating surface, and is exited through the retardation plate 72. The S-polarized light is converted into the P-polarized light by the retardation plate 72, so that in this case, approximately all light are converted into the P-polarized light. It is noted that instead of the polarized light separating surface facing the retardation plate 72, a mirror surface may be formed.

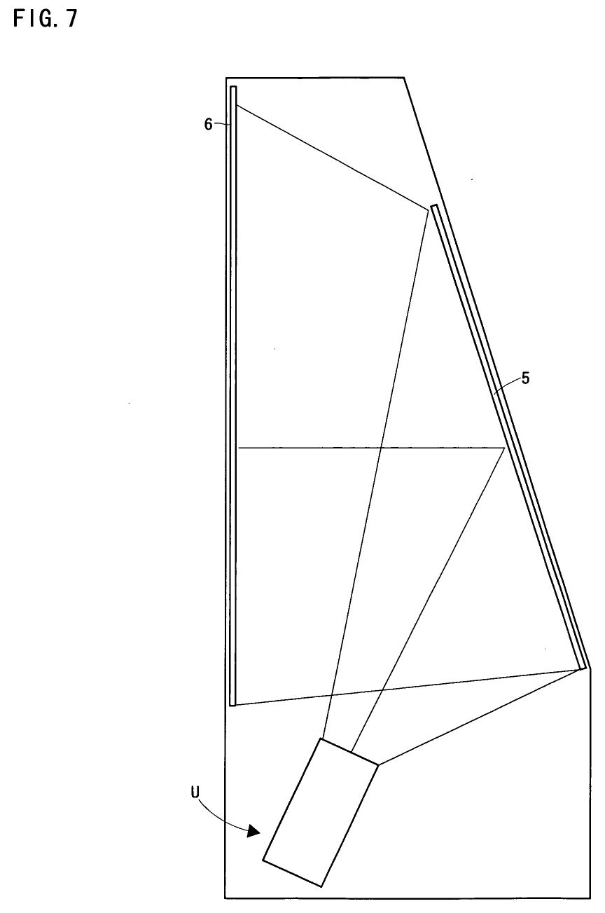

In addition, as shown in FIG. 6, in a case of a reflective liquid crystal display panel 13′, it is possible to adopt a configuration in which a polarizing beam splitter 16 is arranged between the rod integrator 12 and the reflective liquid crystal display panel 13′, for example. In such the configuration, light from a light source (P-polarized light) having passed through the polarized light separating surface of the polarizing beam splitter 16 is reflected by the liquid crystal display panel 13′, and as a result, the light from a light source becomes the image light (S-polarized light). This image light is reflected by the polarized light separating surface of the polarizing beam splitter 16, and is guided to the projection lens. Furthermore, although not shown, it is possible to adopt a configuration in which the reflective liquid crystal display panel 13′ is arranged to be inclined by 45 degrees relative to the optical axes of the LED array 11 and the rod integrator 12, and the projection lens is arranged at a position where to receive the image light obtained as a result of being reflected by this reflective liquid crystal display panel 13′. It is noted that in addition to the reflective liquid crystal display panel 13′, it is possible to use a micro mirror device having a multiplicity of micro mirrors arranged, and capable of driving each mirror separately as a result of energization.

In addition, in the configuration examples described above, the LED array 11 may be provided with a lens for collimating the light. Furthermore, as the LED array, it is possible to use an LED array in which LED chips are arranged in an array shape, and a lens cell (for collimating the light, for example) is arranged by a molding, etc., on a light-emission side of each LED chip, for example. In addition, the light source of respective colors may be formed of one LED. Furthermore, a solid light-emitting element is not limited to the LED, and an organic/inorganic electroluminescence may be used. In addition, besides the solid light-emitting element, a discharge lamp for emitting light in color may be used as the light source, etc.

Furthermore, although in the above embodiments, the projection axes of a plurality of the units for projecting image light 10 are parallel one another, a configuration in which projection optical axes of the plurality of the units for projecting image light 10 intersect on the screen 6 is not to be excluded. In addition, instead of the projection lens 14, it is possible to adopt a configuration in which a projection-use mirror is used.

Although the present invention has been described in detail by the use of illustration, the present invention is merely described by the use of Figures and examples, and thus, it is obvious that the present invention is not limited thereto. The spirit and the scope of the present invention are limited only by the terms in the attached claims.

What is claimed:

1. A rear projection display, comprising a plurality of optical systems for projecting image light in color, each of the plurality of optical systems for projecting image light in color formed of:
a light source for emitting light in color;
a light valve for generating image light in color by transmitting or reflecting the light in color from the light source; and
a projection portion for projecting the image light in color obtained as a result of passing through the light valve, wherein
each of the image light in color from each of the optical systems for projecting image light in color is superposed one another on a rear side of a screen, and as a result, an image in full color is displayed.

2. A rear projection display according to claim 1, wherein each of the optical systems for projecting image light in color is provided with an optical integrator for guiding to the light valve the light in color from the light source so as to render uniform intensity of the light in color within a surface of the light valve.

3. A rear projection display according to claim 1, wherein each of the optical systems for projecting image light in color is provided with a polarization conversion system for supplying to the light valve light in color of which polarization direction is directed to a common direction.

4. A rear projection display according to claim 1, wherein projection optical axes of the projection portions in the plurality of systems of projecting the image light in color are parallel each other, and the light valve or a component including the light valve in all or at least one optical system for projecting image light in color are shifted relative to the projection optical axes of the projection portions.

5. A rear projection display according to claim 4, wherein all or at least one optical system for projecting image light in color is provided with an optical-axis shift mechanism for shifting the light valve or the component including the light valve within a surface perpendicular to the projection optical axis.

6. A rear projection display according to claim 4, wherein all or at least one optical system for projecting image light in color is provided with an optical-axis shift mechanism for shifting the projection portion of the optical system for projecting image light in color within a surface perpendicular to the projection optical axis.

7. A rear projection display according to claim 1, wherein the optical system for projecting image light in color provided with a light source of which light amount is smaller than those of the light sources of the other optical systems for projecting image light in color is provided with a light valve larger in size than the other light valves.

8. A rear projection display according to claim 1, comprising:
as the plurality of optical systems for projecting image light in color,
an optical system for projecting image light in red for projecting image light in red;
an optical system for projecting image light in green for projecting image light in green; and
an optical system for projecting image light in blue for projecting image light in blue.

9. A rear projection display according to claim 8, wherein the plurality of optical systems for projecting image light in color are arranged in such a manner that lines connecting centers of the optical axes of the optical systems for projecting image light in color are in a triangular shape.

10. A rear projection display according to claim 1, comprising:
as the plurality of optical systems for projecting image light in color,
an optical system for projecting image light in red for projecting image light in red;
an optical system for projecting image light in green for projecting image light in green;
an optical system for projecting image light in blue for projecting image light in blue; and
an optical system for projecting image light in another color for projecting image light in another color having a central wavelength different from those of the above colors.

11. A rear projection display according to claim 10, wherein the plurality of optical systems for projecting image light in color are arranged in two rows and two lines so that lines connecting centers of the optical axes of the optical systems for projecting image light in color are in a square shape.

12. A rear projection display according to claim 1 or 10, wherein the plurality of optical systems for projecting image light in color are arranged abreast so that the projection optical axes of the optical systems for projecting image light in color exist within the same plane.

13. A rear projection display according to claim 1, wherein the light source is formed of one or a plurality of solid light-emitting elements.

14. A rear projection display according to claim 1, comprising a transmission-type liquid crystal display panel without a micro lens array as the light valve.

15. A rear projection display according to claim 1, wherein curved-surfaced mirrors are arranged on respective projection sides of the image light in color of the plurality of optical systems for projecting image light in color.

16. A rear projection display according to claim 1, wherein the light sources of the plurality of optical systems for projecting image light in color are arranged on the same plane, and the light sources are cooled by a common cooling device.

17. A rear projection display according to claim 16, wherein the cooling device is a liquid-cooling device.

18. A rear projection display according to claim 1, wherein dust is removed from air taken-in so as to generate cleansed air, and the cleansed air is blown so as to cool the light valves of the plurality of optical systems for projecting image light in color.
